(19) United States
(12) Patent Application Publication
(10) Pub. No.: US 2018/0300758 A1
(43) Pub. Date: Oct. 18, 2018

(54) EVENT-BASED INFORMATION

(71) Applicant: NewsRx, LLC, Atlanta, GA (US)

(72) Inventors: Charles W. Henderson, Atlanta, GA (US); Alan D. Henderson, Watkinsville, GA (US); Chantay P. Jones, Marietta, GA (US); Kalani K. Rosell, New Haven, CT (US)

(21) Appl. No.: 15/490,190

(22) Filed: Apr. 18, 2017

(51) Int. Cl. G06Q 30/02

(52) U.S. Cl. CPC G06Q 30/0255; G06Q 50/01; G06Q 30/0277

(57) ABSTRACT

Technologies are described herein for event based advertisements. According to some examples, event data is extracted from event information received by a news source. One or more advertisements are determined from the event data. Users relevant to the determined advertisements are determined, whereby the determined advertisements are transmitted to the determined users.

### BACKGROUND

Online marketing is generally directed towards user activity online. For example, when a user searches for information using an online search engine, the search as well as the user activity is tracked. The user activity is stored and, using various algorithms, ads directed to the user activity are placed on webpages accessed by the user. Although in some instances the advertisements do have some level of accuracy, the accuracy can be low in various circumstances.

For example, if multiple users share the same computer, advertisements directed to one user may not be applicable to another user sharing the same computer. In another example geared towards social media, multiple individuals, such as a husband and wife, may use the same social media account. The thoughts and activity of one of the users of the social media account may cause the generation of advertisements when the other user of the social media account is using the social media account.

It is with respect to these and other considerations that the disclosure made herein is presented.

### SUMMARY

Technologies are described herein for event-based information. Generally described, a system receives an event notification from an event source. Once an event notification is received, the system receives information of an event from the event source. The system extracts event data related to the event, such as, but not limited to, the location of the event, the type of event, any individuals associated with the event, and the like. The system, thereafter, determines one or more advertisements based on the event. Using the determined advertisements, the system determines one or more users to transmit the determined advertisements to. It should be understood that the presently disclosed subject matter is not limited to advertisements, as other information may be provided as well.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an event-based information system.

FIG. 2 is a screen diagram showing the event-based information system 100 in use on a user device.

FIG. 3 is a screen diagram showing the event-based information system 100 in use in conjunction with a communication system.

FIG. 4 is a flow diagram showing aspects of a method 400 disclosed herein for event based advertisements.

FIG. 5 is a computer architecture diagram illustrating an illustrative computer hardware and software architecture for a computing system capable of implementing the technologies presented herein.

### DETAILED DESCRIPTION

The following detailed description is directed to technologies for event-based information. Various examples of the presently disclosed subject matter use event data to determine advertisements (or other information) to send to one or more users. In one example use, an event can be an automobile accident. The event source can be a news source, a social feed, or other source of the event. The system extracts event data such as the location, individuals involved, the type of event (an accident), and the like.

In an example, the event data can include the type of event (automobile accident), the location of the event (a major intersection), and the number of individuals involved, such as the number of people that normally pass through the intersection or those injured in the automobile event. Once the event data is determined, one or more advertisements can be determined based on the event data. For example, a user in the general vicinity of the event may be reading about the event on a computer device. The event-based advertisement system can determine that an appropriate advertisement may be car insurance and direct that advertisement towards the user when accessing information about the event.

Various implementations of the presently disclosed subject matter can improve upon current systems. For example, limitations of current advertisement methods can be overcome. As noted above, current advertisement systems are typically based on user activity. However, in most instances, the actual user may not be known to the advertisement system. Thus, in some instances, advertisements directed to one user based on the user's activity may actually be seen by another user with different preferences. Implementing an event-based advertisement system can reduce the use of system resources by limiting advertisements based on events that can be applicable to multiple users. Thus, for one determination, multiple users can be reached out to, whereas in older systems, a determination (using computing resources) is made for each user. Other technical advances may be realized as well.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, aspects of technologies for event-based information will be presented.

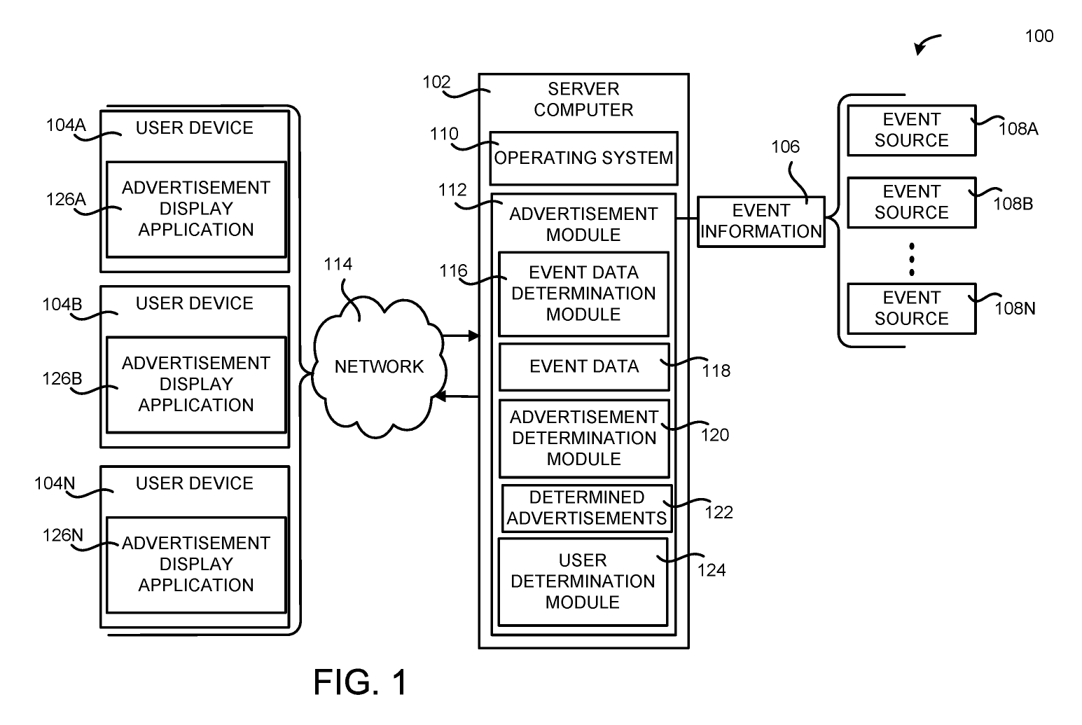

Referring now to FIG. 1, aspects of an event-based information system 100 for event based advertisements are described. The event-based information system 100 shown in FIG. 1 includes a server computer 102 and user devices 104A-104N (hereinafter generally referred to as “user devices 104,” and individually as “user device 104A,” “user device 104B,” and the like). In some examples, the server computer 102 receives event information 106 from one or more event sources 1083A-108N (hereinafter generally referred to as “event sources 108,” and individually as “event source 108A,” “event source 108B,” and the like).

The server computer 102 executes an operating system 110. The operating system 110 is a computer program for controlling the operation of the server computer 102. The operating system 110 executes an advertisement module 112. The advertisement module 112 is used to determine information, in this instance, advertisements, to send to the user devices 104 through network 114, as described in more detail below.

According to various implementations, the functionality of the server computer 102, or the user devices 104 can be provided by a personal computer (“PC”) such as a desktop, tablet, or laptop computer system. In some other examples, the functionality of the server computer 102 or the user devices 104 can be provided by other types of computing systems including, but not limited to, a handheld computer, a netbook computer, an embedded computer system, a mobile telephone, a smart phone, or another computing device.

As noted above, the advertisement module 112 determines one or more advertisements to transmit to the user devices 104. In some examples, the advertisement module 112 receives the event information 106 from one or more of the event sources 108. The event information 106 can vary, but can include news stories, social media postings, documents uploaded to an Internet website, and the like. The present disclosed subject matter is not limited to any particular type of event. As used herein, an “event” refers to an occurrence, such as an action taking place, the posting of information, and the like.

To determine one or more advertisements using the event information 106, the advertisement module 112 invokes an event data determination module 116. The event data determination module 116 analyzes the event information 106 to determine event data 118 associated with event information 106. The event data 118 can vary based on the event information 106. One example of event information 106 was provide above in relation to an automobile accident. The event data 118 can include data such as the location, the type of event, the number of people involved, the impact of the event, and the like.

In another example, if the event information is a posting of an academic paper on a particular technical or scientific subject, the event data 118 can include the topic of the paper, the author, the university or organization supporting the research relating to the academic paper, and a type of user that may have an interest in alignment with the academic paper. For example, a user may have one or more social media, professional, or other postings on subjects or opinions that include information associated with or related to the academic paper. The presently disclosed subject matter is not limited to any particular event information 106 or event data 118.

Once the event data 118 is determined, the advertisement module 112 invokes an advertisement determination module 120. The advertisement determination module 120 receives the event data 118 and determines advertisements (or other information), hereinafter referred to as determined advertisements 122, based on the event data 118.

The determined advertisements 122 can vary. For example, the event data 118 can include that a particular person was involved in an automobile accident. The determined advertisements 122 can be advertisements for such things as car insurance, flowers, attorneys, and the like. It should be understood that there may be one or more determined advertisements 122. Continuing with the example provided above, the person may be a minor female. The determined advertisements 122 may be insurance for a child and child protective seats.

The advertisement module 112 thereafter invokes the user determination module 124 to determine one or more users to transmit the determined advertisements to 122. Continuing with the example provided above, the users may be parents with minor children that may have a certain probability of reading the event information. For example, the determined advertisement 122 may be an advertisement for a child protective seat for users with children in the general area of the automobile accident. The users in the general area of the automobile accident may be more likely to come across the event information 106.

The user determination module 124 can also provide additional information and capabilities. In some examples, the user determination module 124 can be used to determine one or more individuals as “leads” for sales. Using the event data 118, the users (leads) can be filtered and prioritized. In other examples, the users (leads) can be associated with certain labels that, when matched to various aspects of the event data 118 (such as location, age, income, and the like), are identified as users (leads) for event data 118 when generated.

As noted above, the users (leads) can be prioritized. The prioritization can be based on various factors, including relevancy to particular event data 118. For example, a profile of a user stored in the user determination module 124 may list age, sex, weight, profession, work location, and income. The user may be prioritized to a high level if the event data 118 includes information relevant to the gender of the user (lead), and may be prioritized at a lower level if the event data 118 includes information relevant to a particular profession. The reason for the prioritization may vary, however, in some examples, the prioritization may be based on an affinity of data in the user profile and the event data 118.

For example, it may be determined that gender information may be more determinative of a purchasing decision for a lead than a profession. In some examples, if purchasing information is provided, the user priorities may be adjusted. The affinity can be a likelihood of individual to engage based on event data, prediction of customer needs, tendencies based on individual's behavior in event, such as positive view, negative view of success, and the like.

Other factors for determining affinity (and prioritization) may be used as well. Some examples include, but are not limited to, determining interests for ads and marketing based on profile indicators: geography, interests based on key words, interests based on topics, position, organization, reading habits, written statements or written comments or written conclusions, address, job title, names of coworkers, personal or professional interests. In further examples, the users may be associated with an email address and can be presented with an email used for marketing purposes.

In some examples, the determined advertisements 122 may be provided when the users access the event information 106. In these examples, the determined advertisements 122 may be more impactful or meaningful, as the users may relate more to the determined advertisements 122 while they are reading or accessing the event information 106.

The advertisement module 112 transmits the determined advertisements 122 to the user devices 104 for display in an advertisement display application 126A-126N (hereinafter generally referred to as “advertisement display applications 126,” and individually as “advertisement display application 126A,” “advertisement display application 126B,” and the like). In some examples, the advertisement display applications 126 can be Internet browsers, word processing applications, mobile applications, email, and the like. In general, any format capable of receiving and displaying advertisements (or other information relating to an event) can be used within the context of the presently disclosed subject matter.

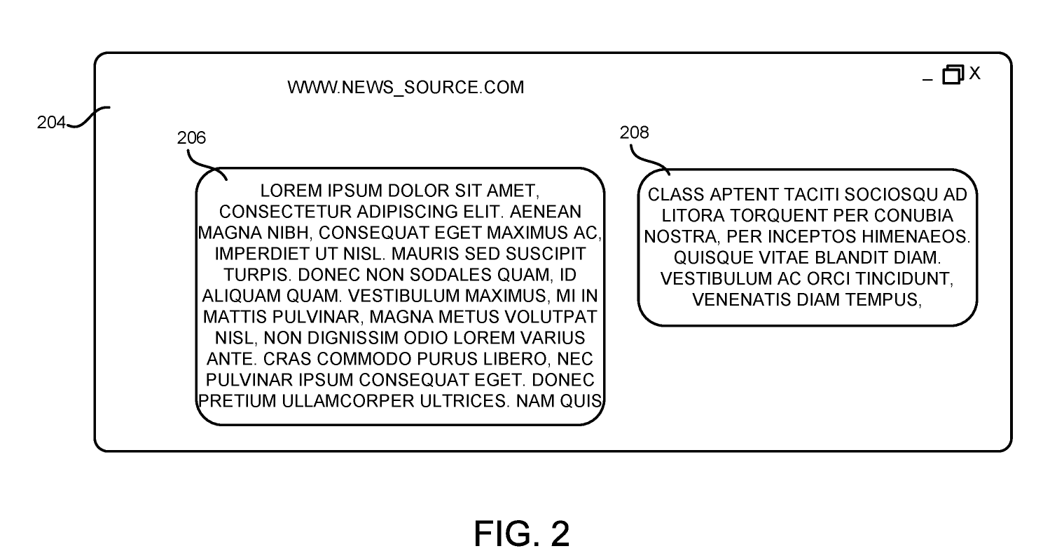

FIG. 2 is a screen diagram showing the event-based information system 100 in use on a user device, such as the user devices 104 of FIG. 1. In FIG. 2, the user (not illustrated) using a user device, such as user device 104A of FIG. 1, is causing to be executed on the user device 104A an Internet browser 204. As illustrated, the Internet browser 204 has accessed the website associated with the top-level domain, “www.news_source.com.” Displayed within the Internet browser 204, a news section 206 is provided. The news section 206 has displayed therein a story about an event.

Also displayed within the Internet browser 204 is advertisement section 208. The advertisement displayed within advertisement section 208 is provided by an advertisement module, such as the advertisement module 112 of FIG. 1. In some examples, the contents of the advertisement section 208 can be related to various aspects of the information in the news section 206. For example, the advertisement module 112 of FIG. 1 may have received event information 106 from an event source 108A, such as “www.news_source.com” displayed within the Internet browser 204. The event data determination module 116 can determine that the event data 116 to generate an advertisement includes an automobile accident in a certain location. The advertisement module 112 can then cause the creation of an advertisement for products or services relevant to the event data 118, such as life insurance policies, child seats, and the like.

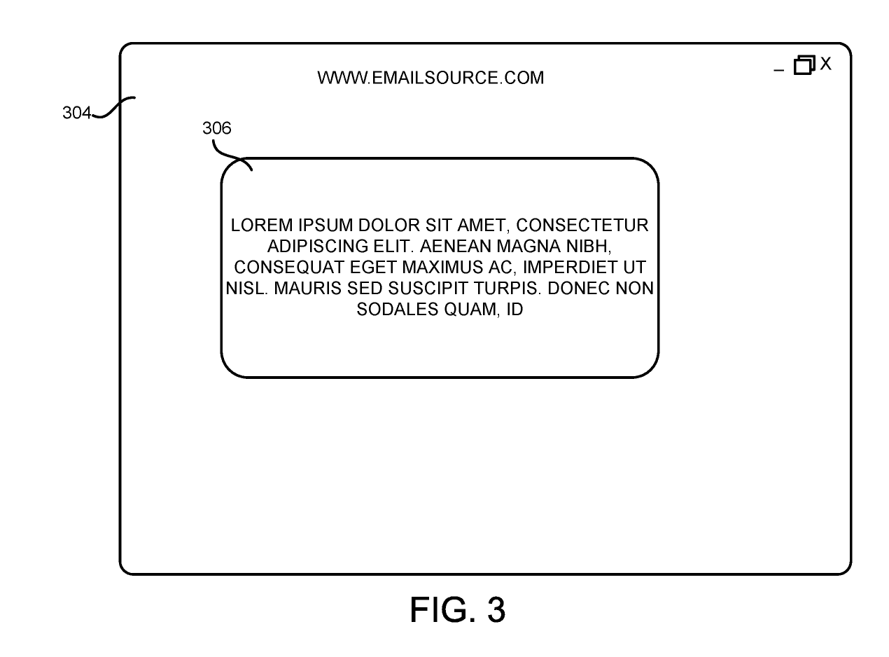

FIG. 3 is a screen diagram showing the event-based information system 100 in use in conjunction with a communication system. In FIG. 3, the user (not illustrated) using a user device, such as user device 104A of FIG. 1, is causing to be executed on the user device 104A an email service 304. As illustrated, in FIG. 3, the email service 304 has displayed therein an email 306. In some examples, the email 306 is provided by an advertisement module, such as the advertisement module 112 of FIG. 1.

In some examples, the contents of the email 306 can be related to various aspects of the information relating to an event associated in some way with the user. For example, the email 306 can be a journal article. The journal article can be based on an event such as, but not limited to, a discovery of a new scientific process, drug, or other area of scientific study. For example, the advertisement module 112 of FIG. 1 may have received event information 106 from an event source 108A that a group of scientists have published an article disclosing new information about an area of study. The user's email address may be associated with a list of individuals who have shown an interest in that area of study. The email list may be stored in a data store accessible to a user determination module, such as the user determination module 124 of FIG. 1.

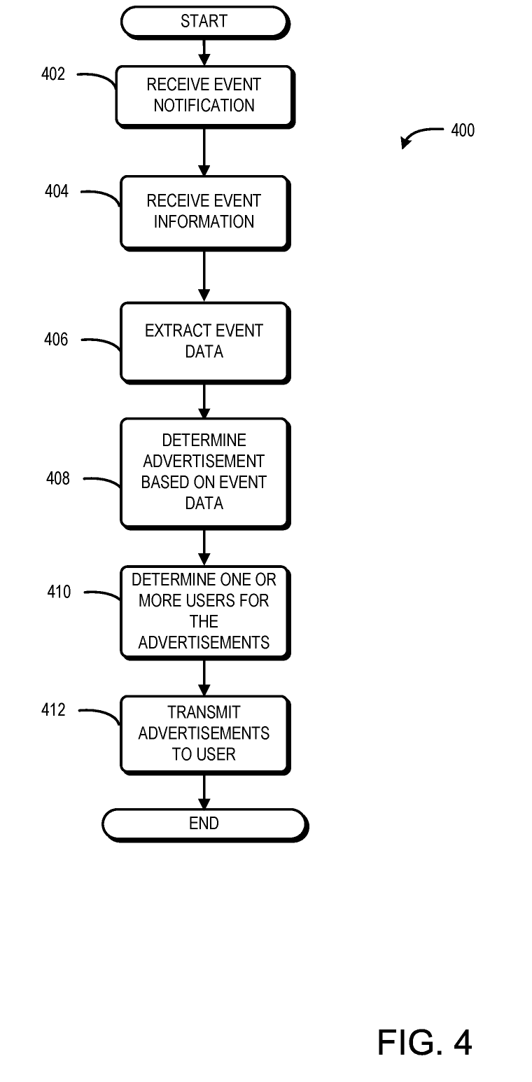

FIG. 4 is a flow diagram showing aspects of a method 400 disclosed herein for event based advertisements. It should be understood that the operations of the method 400 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 400 can be ended at any time and need not be performed in its entirety. Some or all operations of the method 400, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 400 disclosed herein is described as being performed by the server computer 102 via execution of computer executable instructions such as, for example, the advertisement module 112. As explained above, the advertisement module 118 can include functionality for generating advertisements based on events.

While the method 400 is described as being provided by the server computer 102, it should be understood that the server computer 102 can provide the functionality described herein via execution of various application program modules and/or elements. Additionally, devices other than, or in addition to, the server computer 102 can be configured to provide the functionality described herein via execution of computer executable instructions other than, or in addition to, the advertisement module 112. As such, it should be understood that the described configuration is illustrative, and should not be construed as being limiting in any way.

The method 400 begins at operation 402, where an event notification is received at the server computer 102. The event notification is a notification that provides the server computer 102 within information that an event occurred that may be relevant to one or more advertisements. In some examples, an event notification is not used. The presently disclosed subject matter is not limited to the use of event notifications.

At operation 404, event information 106 is received. The event information 106 can vary. In some examples, the event information 106 is a news story generated by one of the event sources 108 relating to an event. The event information 106 can also be other types of events, such as birthdays, sports events, scientific journal publications, and the like. The presently disclosed subject matter is not limited to any particular type of event information.

At operation 406, event data 118 is extracted from the event information 106. In some examples, the event data 118 are salient facts relating to the event. For example, event data 118 for a news story about a car accident can include the area of the accident, the number and identity of the individuals involved, the automobiles involved, and the like.

At operation 408, one or more advertisements 122 are determined from the event data 118. The determined advertisements 122 can be indexed against a list of event data 118 to show association with the event data 122. For example, if the event is an automobile accident, the possible advertisements that have not been determined as being associated with an automobile accident can be filtered out (e.g. removed from consideration).

For example, an advertisement about kids' birthday party services may not be indexed (or identified) as being associated with an automobile accident. The possible advertisements can be further filtered using other terms (or keywords) that have been generated as the event data 118. The determined advertisements 122 can be the result of a filtering process.

At operation 410, one or more users are determined for the determined advertisements 122. The users may be determined based on information received at the system and stored as a list of users (or leads). In these configurations, a user profile may be generated for a particular user. The user profile may include information about the user, such as age, marital status, sex, political preferences, location, education level, and the like. The determined advertisements 122 may have data associated with them that identify one or more information about a user that the advertisement, using the event data, is applicable to. For example, a determined advertisement 122 may be associated with users having a particular education level. Users without the education level may be filtered as users to receive the determined advertisement 122. In some instances, if no user is determined to be associated with any of the determined advertisements 122, the determined advertisements 122 may not be transmitted.

In these and other examples, various implementations of the presently disclosed subject matter use a multi-step process in an attempt to determine relevant advertisements. As noted above, the determined advertisements 122 are based on the event data 118. In some conventional systems, advertisements are determined solely on online activities of a user using a particular computer. Once the determined advertisements 122 are determined, further implementations of the presently disclosed subject matter determine users that “match” the keywords or other information used for the determined advertisements 122.

At operation 412, the determined advertisements 122 are transmitted to the determined users. The method 400 can thereafter end.

The present disclosure also encompasses the subject matter set forth in the following clauses:

Clause 1: A computer-implemented method, the method comprising: receiving event information of an event; extracting event data from the event information; determining at least one communication from the event data; determining one or more users to receive the at least one communication; and transmitting the at least one communication for receipt by the one or more users.

Clause 2: The computer-implemented method of any one or more of the previous clauses, further comprising receiving an event notification of the event, wherein the event notification comprises information that the event occurred.

Clause 3: The computer-implemented method of any one or more of the previous clauses, wherein the event information comprises a news story or a scientific journal publication.

Clause 4: The computer-implemented method of any one or more of the previous clauses, wherein the at least one communication is an advertisement.

Clause 5: The computer-implemented method of any one or more of the previous clauses, wherein determining the at least one communication from the event data comprising indexing the event data against a plurality of communications and filtering out communications that are not associated with the event data.

Clause 6: The computer-implemented method of any one or more of the previous clauses, wherein determining the one or more users to receive the at least one communication comprises determining whether or not the one or more users have profile information that is associated with the event data.

Clause 7: A computer-readable storage medium having computer-executable instructions stored thereupon that, when executed by a computer, cause the computer to: receive event information of an event; extract event data from the event information; determine at least one communication from the event data; determine one or more users to receive the at least one communication; and transmit the at least one communication for receipt by the one or more users.

Clause 8: The computer-readable storage medium of any one or more of the previous clauses, further comprising computer-executable instructions to receive an event notification of the event, wherein the event notification comprises information that the event occurred.

Clause 9: The computer-readable storage medium of any one or more of the previous clauses, wherein the event information comprises a news story or a scientific journal publication.

Clause 10: The computer-readable storage medium of any one or more of the previous clauses, wherein the at least one communication is an advertisement.

Clause 11: The computer-readable storage medium of any one or more of the previous clauses, wherein the computer-executable instructions to determine the at least one communication from the event data comprises computer-executable instructions to index the event data against a plurality of communications and filtering out communications that are not associated with the event data.

Clause 12: The computer-readable storage medium of any one or more of the previous clauses, wherein the computer-executable instructions to determine the one or more users to receive the at least one communication comprises computer-executable instructions to determine whether or not the one or more users have profile information that is associated with the event data.

Clause 13: A system comprising: a processor; and a computer-readable storage medium in communication with the processor, the computer-readable storage medium having computer-executable instructions stored thereupon which, when executed by the processor, cause the processor to receive event information of an event; extract event data from the event information; determine at least one communication from the event data; determine one or more users to receive the at least one communication; and transmit the at least one communication for receipt by the one or more users.

Clause 14: The system of any one or more of the previous clauses, further comprising computer-executable instructions to receive an event notification of the event, wherein the event notification comprises information that the event occurred.

Clause 15: The system of any one or more of the previous clauses, wherein the event information comprises a news story or a scientific journal publication.

Clause 16: The system of any one or more of the previous clauses, wherein the at least one communication is an advertisement.

Clause 17: The system of any one or more of the previous clauses, wherein the computer-executable instructions to determine the at least one communication from the event data comprises computer-executable instructions to index the event data against a plurality of communications and filtering out communications that are not associated with the event data.

Clause 18: The system of any one or more of the previous clauses, wherein the computer-executable instructions to determine the one or more users to receive the at least one communication comprises computer-executable instructions to determine whether or not the one or more users have profile information that is associated with the event data.

Clause 19: The system of any one or more of the previous clauses, further comprising computer-executable instructions to prioritize a list of users based on an affinity of a factor of a user profile associated with users in the list of users to event data.

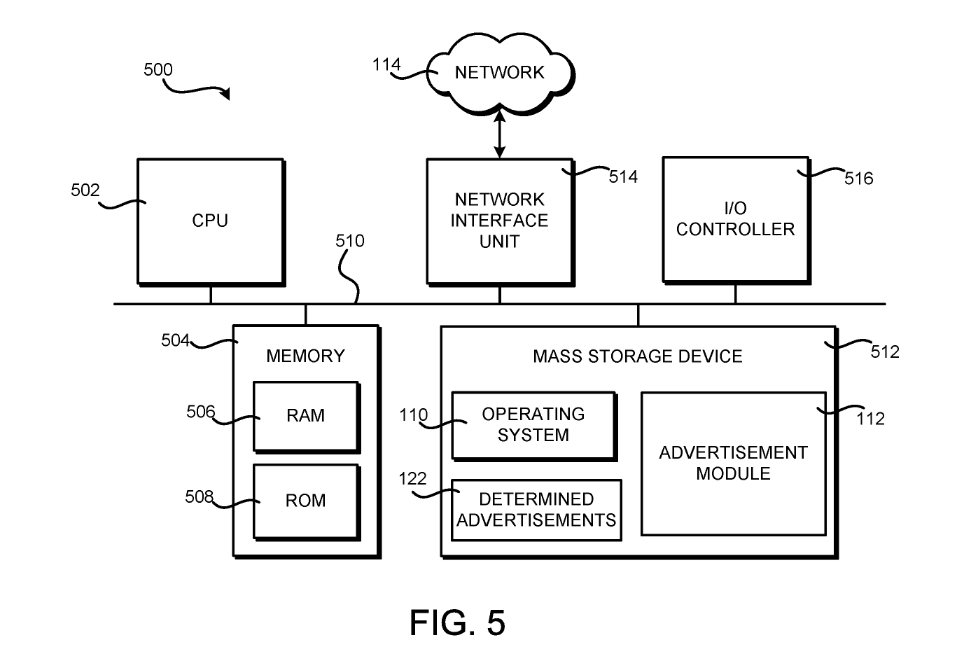

FIG. 5 illustrates an illustrative computer architecture 500 for event based advertisements. Thus, the computer architecture 500 illustrated in FIG. 5 illustrates an architecture for a server computer, mobile phone, a smart phone, a desktop computer, a netbook computer, a tablet computer, and/or a laptop computer. The computer architecture 500 can be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 110 and one or more application programs or data stores including, but not limited to, the advertisement module 112 and the determined advertisements 122.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 500 can operate in a networked environment using logical connections to remote computers through a network such as the network 108. The computer architecture 500 can connect to the network 114 through a network interface unit 514 connected to the bus 510. It should be appreciated that the network interface unit 514 can also be utilized to connect to other types of networks and remote computer systems. The computer architecture 500 can also include an input/output controller 516 for receiving and processing input from a number of other devices, including a keyboard, mouse, or electronic stylus (not shown in FIG. 5). Similarly, the input/output controller 516 can provide output to a display screen, a printer, or other type of output device (also not shown in FIG. 5).

It should be appreciated that the software components described herein can, when loaded into the CPU 502 and executed, transform the CPU 502 and the overall computer architecture 500 from a general-purpose computing system into a special-purpose computing system customized to facilitate the functionality presented herein. The CPU 502 can be constructed from any number of transistors or other discrete circuit elements, which can individually or collectively assume any number of states. More specifically, the CPU 502 can operate as a finite-state machine, in response to executable instructions contained within the software modules disclosed herein. These computer-executable instructions can transform the CPU 502 by specifying how the CPU 502 transitions between states, thereby transforming the transistors or other discrete hardware elements constituting the CPU 502.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 can include other types of computing devices, including hand-held computers, embedded computer systems, personal digital assistants, and other types of computing devices known to those skilled in the art. It is also contemplated that the computer architecture 500 might not include all of the components shown in FIG. 5, can include other components that are not explicitly shown in FIG. 5, or might utilize an architecture completely different than that shown in FIG. 5.

Based on the foregoing, it should be appreciated that technologies for event based advertisements have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A computer-implemented method, the method comprising:
receiving event information of an event;
extracting event data from the event information;
determining at least one communication from the event data;
determining one or more users to receive the at least one communication; and
transmitting the at least one communication for receipt by the one or more users.

2. The computer-implemented method of claim 1, further comprising receiving an event notification of the event, wherein the event notification comprises information that the event occurred.

3. The computer-implemented method of claim 1, wherein the event information comprises a news story or a scientific journal publication.

4. The computer-implemented method of claim 1, wherein the at least one communication is an advertisement.

5. The computer-implemented method of claim 1, wherein determining the at least one communication from the event data comprising indexing the event data against a plurality of communications and filtering out communications that are not associated with the event data.

6. The computer-implemented method of claim 1, wherein determining the one or more users to receive the at least one communication comprises determining whether or not the one or more users have profile information that is associated with the event data.

7. A computer-readable storage medium having computer-executable instructions stored thereupon that, when executed by a computer, cause the computer to:
receive event information of an event;
extract event data from the event information;
determine at least one communication from the event data;
determine one or more users to receive the at least one communication; and
transmit the at least one communication for receipt by the one or more users.

8. The computer-readable storage medium of claim 7, further comprising computer-executable instructions to receive an event notification of the event, wherein the event notification comprises information that the event occurred.

9. The computer-readable storage medium of claim 7, wherein the event information comprises a news story or a scientific journal publication.

10. The computer-readable storage medium of claim 7, wherein the at least one communication is an advertisement.

11. The computer-readable storage medium of claim 7, wherein the computer-executable instructions to determine the at least one communication from the event data comprises computer-executable instructions to index the event data against a plurality of communications and filtering out communications that are not associated with the event data.

12. The computer-readable storage medium of claim 7, wherein the computer-executable instructions to determine the one or more users to receive the at least one communication comprises computer-executable instructions to determine whether or not the one or more users have profile information that is associated with the event data.

13. A system comprising:
a processor; and
a computer-readable storage medium in communication with the processor, the computer-readable storage medium having computer-executable instructions stored thereupon which, when executed by the processor, cause the processor to
receive event information of an event;
extract event data from the event information;
determine at least one communication from the event data;
determine one or more users to receive the at least one communication; and
transmit the at least one communication for receipt by the one or more users.

14. The system of claim 13, further comprising computer-executable instructions to receive an event notification of the event, wherein the event notification comprises information that the event occurred.

15. The system of claim 13, wherein the event information comprises a news story or a scientific journal publication.

16. The system of claim 13, wherein the at least one communication is an advertisement.

17. The system of claim 13, wherein the computer-executable instructions to determine the at least one communication from the event data comprises computer-executable instructions to index the event data against a plurality of communications and filtering out communications that are not associated with the event data.

18. The system of claim 13, wherein the computer-executable instructions to determine the one or more users to receive the at least one communication comprises computer-executable instructions to determine whether or not the one or more users have profile information that is associated with the event data.

19. The system of claim 13, further comprising computer-executable instructions to prioritize a list of users based on an affinity of a factor of a user profile associated with users in the list of users to event data.
